(19) United States
(12) Patent Application Publication
(10) Pub. No.: US 2016/0165361 A1
(43) Pub. Date: Jun. 9, 2016

(54) APPARATUS AND METHOD FOR DIGITAL SIGNAL PROCESSING WITH MICROPHONES

(71) Applicant: Knowles Electronics, LLC, Itasca, IL (US)

(72) Inventors: Thomas E. Miller, Arlington Heights, IL (US); Daniel Warren, Geneva, IL (US); Brian Cranell, Clarendon Hills, IL (US); Timothy Wickstrom, Elk Grove Village, IL (US); John Beard, Chicago, IL (US)

(21) Appl. No.: 14/953,593

(22) Filed: Nov. 30, 2015

Related U.S. Application Data
(60) Provisional application No. 62/088,072, filed on Dec. 5, 2014.

(51) Int. Cl. H04R 25/00

(52) U.S. Cl. CPC H04R 25/48; H04R 25/43; H04R 2410/01; H04R 2225/43; H04R 2430/01

(57) ABSTRACT

At least a partial seal between a housing of a hearing instrument and an ear canal is provided. First signals are received from an internal microphone disposed in the ear canal. Second signals are received from an external microphone disposed outside of the ear canal. A condition of the at least a partial seal is determined, and when the condition of the at least a partial seal indicates a leak, one or more of the level and the spectrum of the first signals is adjusted to compensate for the leak and producing first adjusted signal. A first amount of the first adjusted signals is blended with a second amount of the second signals to produce a blended signal, the first amount and the second amount selected based upon a level of noise.

### CROSS-REFERENCE TO RELATED APPLICATION

This application claims the benefit of U.S. Provisional Patent Application Ser. No. 62/088,072, filed Dec. 5, 2014, entitled APPARATUS AND METHOD FOR DIGITAL SIGNAL PROCESSING WITH MICROPHONES which is incorporated by reference in its entirety herein.

### FIELD OF THE INVENTION

This application relates to microphones and, more specifically, digital signal processing approaches utilizes with microphones.

### BACKGROUND OF THE INVENTION

Effective communications devices capture the sound of the user's voice, while minimizing the pickup of environmental sounds. Some communications devices are worn on the head with some portion of the device in proximity to the ear, leaving the hands of the user free for other activities. Many users of these devices prefer that the device be unobtrusive; for example, some users may not want to have the microphone placed near the wearer's mouth.

Environmental sounds tend to degrade the signal to noise ratio of signals. One way to avoid environmental sounds is to place a microphone within the ear canal, with a seal at the outer end of the canal. Sound from the mouth is conducted through the body to the ear canal.

The seal traps the vocal sounds within the canal, while keeping wind and environmental noises out of the canal. For clarity, all non-speech sounds will be referred to as environmental sounds. The actual source of these sounds may also be caused by sources that are not external to the device, such as the self-noise of the microphone and electronics.

### BRIEF DESCRIPTION OF THE DRAWINGS

For a more complete understanding of the disclosure, reference should be made to the following detailed description and accompanying drawings wherein:

FIG. 1 comprises a diagram showing an acoustic system disposed in an ear according to various embodiments of the present invention;

FIG. 2 comprises a block diagram of a signal processing module according to various embodiments of the present invention;

FIG. 3 comprises a block diagram of an automated equalizer module according to various embodiments of the present invention;

FIG. 4 comprises a block diagram of a sibilant replacement module according to various embodiments of the present invention;

FIG. 5 comprises a block diagram of a microphone selection module according to various embodiments of the present invention;

FIG. 6 comprises a block diagram of a feedback suppression module according to various embodiments of the present invention;

FIG. 7 comprises a block diagram of a noise reduction module according to various embodiments of the present invention;

FIG. 8 comprises a block diagram of another example of a noise reduction module according to various embodiments of the present invention;

FIG. 9 comprises a graph showing behavior of signals in the noise envelope detection module according to various embodiments of the present invention;

FIG. 10 comprises a graph showing cross fade gains in the microphone selection module according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present approaches provide digital signal processing functions for electrical signals received by microphones. To a typical listener, speech conducted through the body to the canal sounds different than speech in front of the speaker's mouth. In the present approaches, signal processing is utilized to improve the sound quality of voice detected within the ear canal.

These approaches are deployed in housings that are disposed at least partially in the ear and form seals in the ear canal. In particular and to take one example, the level of high frequencies may be amplified. If the seal develops a leak, the amount of sound trapped in the canal is reduced, especially at the low frequencies. Therefore, the level and tonal balance of the user's voice in the canal will be changed. In some aspects an equalizer is used to compensate for this change, and the equalizer can be automatically tuned for optimum compensation. Even with equalization, the sound of the voice in the canal may sound less natural than the sound of the voice outside the ear canal. The external sound can be picked up by a microphone placed near the ear. In these regards and in one approach, the external microphone is used as input when the level of environmental noise is low, and the input is changed to the internal microphone when noise is high.

In moderately noisy conditions where the internal microphone signal is preferred, it may be useful to combine some parts of speech such as sibilant sounds from the external microphone with the signal from the internal microphone. In one example, an automated approach of selecting between or combining the internal and external microphone signals in response to the level of environmental noise without requiring operator intervention is utilized.

Noise reduction algorithms can be used to attempt to remove non-speech elements of the signal from the microphones to improve the intelligibility of the speech. Typically and in previous approaches, these algorithms used a single input. This made it difficult to determine which elements are speech and which are not and errors caused the unwanted removal of speech elements and inclusion of noise elements. In some of the present approaches, noise reduction is made more accurate by comparing the signals from the external and internal microphones. Differences in the speech and environmental sounds in the two signals can be used to guide or control the noise removal algorithm.

In some of the present approaches, a communication system also has a speaker directed to the user's ear, so that the user may hear the far end of the conversation. Signals from this speaker add unwanted input to the internal microphone. Therefore, the speaker signal can also be used to guide or control the noise removal algorithm.

It will be appreciated that the elements described herein can be implemented with any combination of hardware and/or software. In one particular approach, these elements may be implemented using computer instructions stored in memory that are executed on a processing device such as a microprocessor.

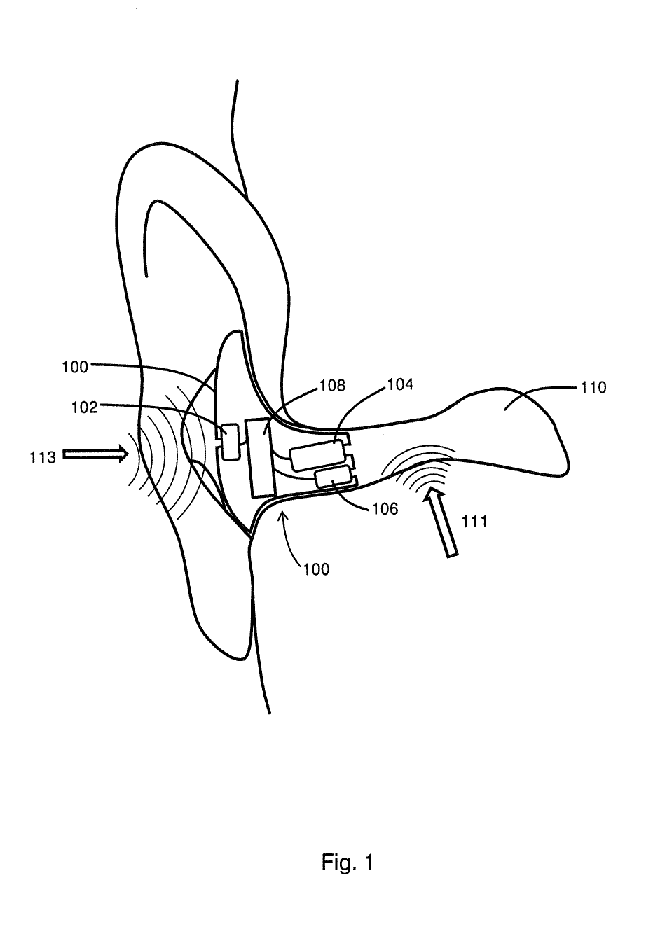

Referring now to FIG. 1, one possible arrangement of transducers is described. A housing 100 includes an external microphone 102, an internal speaker 104, and an internal microphone 106. A signal processing apparatus 108 is also disposed at the housing 100. The housing 100 is disposed at least partially in an ear canal 110. In some aspects, the interior microphone 106 is disposed fully or at least partially within the ear canal 110 and receives sounds from the ear canal 110.

The external microphone 102 picks up sound energy from outside the ear canal 110. This sound energy is converted into an electrical signal and the electrical signal processed by the signal processing apparatus 108.

The internal speaker 104 is disposed fully or at least partially within the ear canal 110 of a user. The speaker 104 converts electrical signals (e.g., those received from the exterior microphone 102) into sound energy that is presented to the user at the ear canal 110. The speaker 104 can be any kind of speaker. In one example, it is a speaker 104 is an armature-type of speaker (e.g., a speaker with a coil, magnets, and a magnetic support structure wherein excitement of the coil by an electrical current causes an armature to move, which in turn moves a diaphragm to create sound). It will be appreciated that the speaker 104 receives additional signals from other devices besides the microphone 102. For example, the speaker 104 receives signals from processor 108, and that these signals may be messages or music created within the processor, music and phone conversation received from a radio link such as Bluetooth, signal from exterior microphone 102, noise-canceling or occlusion-cancelling signals, and so forth.

The internal microphone 106 picks up body conducted sound energy 111 in the ear canal (e.g., from the user speaking) This is processed by the signal processing apparatus 108. The signal processing apparatus 108 processes signals received from the external microphone and the internal microphone, and presents the processed signals for transmission to another entity.

In one aspect and as mentioned, the housing 100 fits at least partially in the ear or ear canal of a user, with one end sealed to the ear canal 110. The seal may be achieved using a rubber ear tip, a custom molded housing, or other approaches. While an airtight seal is optimal, signal processing can be used to compensate for a partial seal when a partial seal is used. Audio ports of the internal microphone 106 and speaker 104 connect or open to the ear canal 110, either directly or through tubing or other controlled acoustic pathways. The speaker 104 and microphone 106 preferably each have their own sound tube to minimize the interaction of the speaker and microphone.

One or more external microphones 102 are disposed to sense external sound energy 113 that is exterior to the ear canal 110. If more than one exterior microphone is used, the signals from the multiple microphones can be combined to form a directional microphone aimed at the wearer's mouth, to improve speech pickup, and reduce noise. The external and internal microphones may be electret or microelectromechanical system (MEMS) type microphone and may have analog or digital output signals. Other examples of microphone configurations are possible.

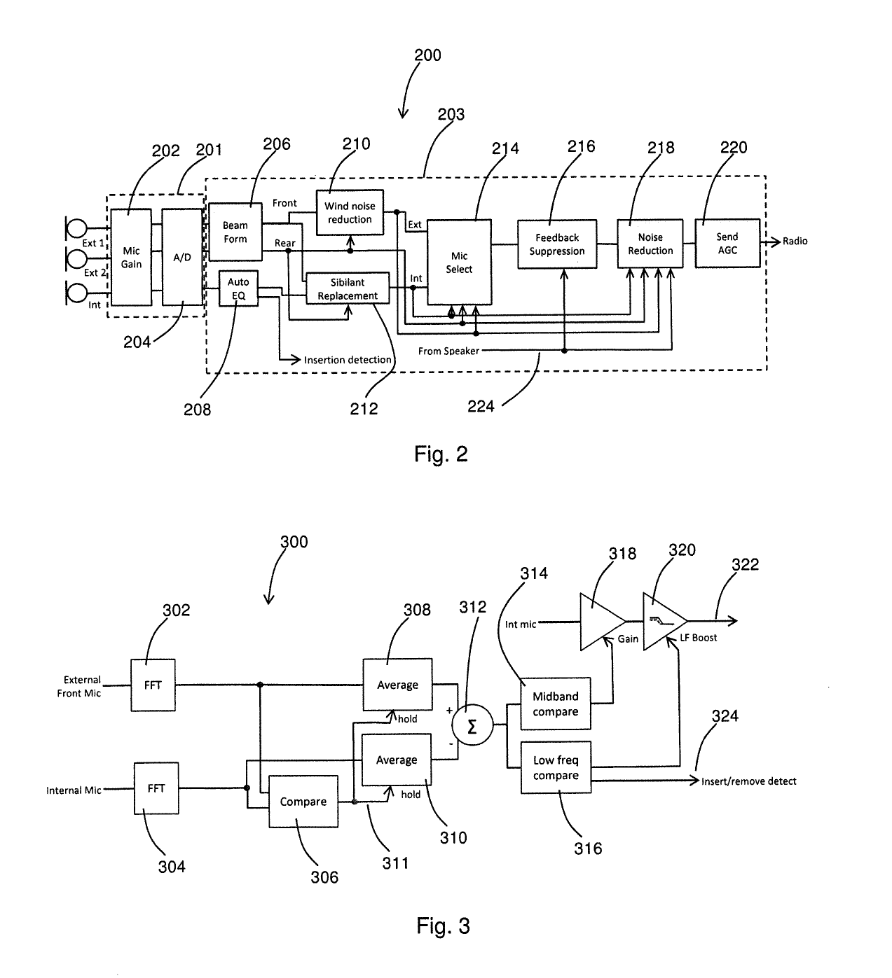

Referring now to FIG. 2, one example of a signal processing apparatus 200 that includes an interface 201 and a digital signal processor 203 is described. The interface 201 includes a microphone gain module 202, and an analog-to-digital converter 204. The DSP 203 includes a beam form module 206, an automated equalizer module 208, a wind noise reduction module 210, a sibilant replacement module 212, a microphone selection module 214, a feedback suppression module 216, a noise reduction module 218, and an automatic gain control (AGC) module 220. The analog-to-digital converter 204 in one aspect is optional; for example, when signals are received from digital microphones, the analog-to-digital converter 204 is not required. Other modules (e.g., the noise reduction module 218, the send AGC module 220, and the beam form module 206) may also be optionally used in some examples. Moreover, it will be understood that the modules of FIG. 2 may be implemented as any combination of hardware and/or software, for example, as computer instructions executed on a processing device.

The outputs of the internal and external microphones (e.g., internal microphone 106 and external microphone 102 in FIG. 1) are connected to an apparatus with the interface 201 with inputs and outputs. In this example, there are two external microphones (with inputs EX1 and EX2) and one internal microphone (with input INT). The microphone gain module 202 provides appropriate gain to the input analog signals. The analog to digital converter 204 converts the microphone analog signals into pulse code modulation (PCM) signals delivered to the output. Portions of the converter 204 may also be used to convert pulse width modulation (PWM) signals from a digital microphone into PCM signals, bypassing the analog gain stage. The sampling rate of the PCM signal is set in one example to be at least 2 times the desired signal bandwidth, and may be 16000 samples per second in one specific example.

The interface 201 is connected to a digital signal processor 203 which performs digital signal processing. The output of the digital signal processor 203 may have a wired or a radio connection 222 to a cellular phone (or other) equipment. The radio connection may conform to the Bluetooth standard in two examples. Other examples are possible. The digital signal processor 203 supplies signals to the speaker (e.g., speaker 104), but the processing of these signals is not described here.

As described before, the interface 201 applies gain and converts the incoming signals into digital form. If there is more than one exterior microphone, the microphone signals are combined by the beam forming module 206 of the DSP 203 to form forward and rearward directed directional sensitivity patterns. In one example, the forward pattern is oriented towards the user's mouth, and the rearward pattern is directed so that a null in the pattern is aimed at the user's mouth.

One function of the beam forming module 206 is to create a large difference in the speech content of the two signals. The directivity of the patterns may be cardioid, hyper-cardioid, super-cardioid, or some other pattern. In one example, hyper-cardioid is preferred for the forward microphone, while a cardioid is preferred for the rear microphone. This provides a high directivity index for the forward pattern, and a high rejection of speech for the rear pattern. The method for beam forming is well established, and will not be described in greater detail here.

The wind noise reduction module 210 applies a wind noise filter to the front signal. This may be performed by applying a high pass filter when wind is detected. The high pass filter is typically a second order 400 Hz filter, and wind can be detected by the level of low frequency energy if only using one microphone. If more than one microphone is used, the relative phase between microphones of the low frequency energy can be used.

The automated equalizer module 208 checks the condition of the seal, and adjusts the level and spectrum of the internal microphone signal to compensate for any leaks in the seal. An insertion detection line 215 indicates when the aid is inserted in the ear canal. This status can be used for example to stop streaming music, or to turn off the power when the device is removed from the ear.

The sibilant replacement module 212 replaces selected frequency components in received speech signal. In these regards, the signal received from the internal microphone may, in many circumstances, have very low energy at high frequencies, often below the system noise level. Therefore, equalization may not be adequate to improve these signals. This limits the clarity of sibilants such as the starting sounds of “send”, “shovel”, and “Zen”. While this limitation is minor for traditional phone conversations that only extend to approximately 3 kHz, wide band telephony and VOIP communication can have a bandwidth of approximately 6 kHz or greater. Therefore, another source is used for high frequency sounds. The external microphone is a useful source for these sounds, provided the signal to noise level is adequate. It will be appreciated that environmental sounds often have little sustained energy above 3 kHz.

The microphone selection module 214 is an automatic input selector that in one aspect uses the external microphone signal as input when exterior environmental noise is low, but changes to use the internal microphone signal as input when environmental noise levels interfere with communication. The change can be a complete substitution of one signal for the other, or can be a blending of the two signals. In one specific approach, the internal and external signals are blended, with the level being proportional to a multiple of the noise level, in a dB or logarithmic sense. This approach creates a very smooth changeover, with no sudden changes in voice quality or the environmental noise level.

The feedback suppression module 216 reduces feedback or echo. In these regards, a speaker may be placed into the canal to provide the return portion of a conversation or phone call via input line 224. In this case, sound from the speaker will be sensed by the internal microphone. This sound is confounding the sensing of the user's own voice, and may cause feedback howling or echoes during some applications such as during a phone call. It may also degrade the performance of the various algorithms described here. A feedback suppression or echo suppression filter will reduce the level of the speaker signal picked up by the internal microphone. In one example, these arrangements use an adaptive filter. A least mean squares algorithm may be used to adjust the filter and minimize the signal at the output. The filter will adapt to match the coupling of the speaker and the microphone. The output of the filter will retain the internal voice pickup, but reduce the level of the speaker signal picked up by the microphone.

The noise reduction module 218 reduces noise in the system. In one example, the speaker signal 224 may be utilized as a reference signal to guide the noise reduction.

The automatic gain control (AGC) module 220 controls the loudness of voice, so that both loud and soft speech are easily heard at the far end of the conversation. This module uses standard limiter or compressor approaches as known to those skilled in the art. In other examples, level correction is applied in multiple frequency bands, to improve the clarity of speech for people who have weak parts of speech, such as very soft sibilants.

Referring now to FIG. 3, one example of an automated equalizer module 300 is described. The module 300 includes a first Fast Fourier Transform (FFT) block 302, a second FFT block 304, a compare block 306, a first average block 308, a second average block 310, a summer 312, a mid-band compare block 314, a low frequency compare block 316, a gain element 318, and a low frequency (LF) boost element 320. The signals from the external microphone and the internal microphone are the inputs to the control section. If a directional microphone signal is available, the forward facing directional signal is preferred in some examples. The energy of the signal may be analyzed by dividing the signal into blocks, possibly of 512 samples each. Each block is converted to the frequency domain using the first FFT block 302 and the second FFT block 304. Each data point from the FFT represents the energy in a narrow range of frequencies, which herein will be referred to as a bin.

The energy may also be estimated by using filters to separate the signal into different frequency bands, then integrating the energy over a short time period, such as 20 ms. Using either approach, the resulting data rate is much lower than the sampling rate, reducing the calculation requirement of the digital signal processor.

The energy of the voice from each microphone is averaged over a long period of time, such as several seconds, by the first average block 308 and the second average block 310. The averaging time should be longer than individual words, to avoid distracting fluctuations in the equalization settings. The averaging blocks 308 and 310 may use separate attack and decay times, with the attack time used when the signal level is increasing, and the decay time used when the signal level is decreasing. A shorter attack time will allow a quicker assessment of the equalization at startup, while the longer decay time assures stable operation. The average energy can be tracked separately for each frequency bin of the FFT, or can be combined into fewer frequency bands. Combining information makes the averages more robust, but less spectral information is available to drive the adjustment section. Combining data into frequency bands using the mel scale or ⅓^{rd} octave bands provides an excellent match to human perception of timbre. Higher frequency resolution offers little improvement for this system.

To measure only the voice and exclude environmental sounds, a voice activity detector (VAD) is used. Voice activity is detected by the compare block 306 that compares the energy in the two inputs. If the energy from the exterior microphone is greater than the interior microphone, the voice is determined to not be active, and updates to the average are stopped by applying a hold signal 311 to the average blocks 308 and 310. An additional offset can be used in the comparison, to compensate for expected differences between the internal and external microphone. The offset can be factory determined, or can be self-adjusting, using very long-term comparisons of the two microphone's spectra. The interior microphone signal may be contaminated by noise, for example the self-noise of the microphone, or signals from a speaker in the canal. Therefore, a noise reduction block may be used to clean the microphone signal before it is compared with an exterior signal. Noise reduction strategies will be discussed elsewhere herein.

Other means can be used for voice detection, such as comparing the level of the interior microphone to a fixed threshold, comparing the phase of the internal and external signals, or by performing a cross correlation between the internal and external signals. Voice activity can be detected individually in each frequency band, or information from multiple bands can be combined first. Other voice activity detection approaches can also be utilized.

The spectral averages are then used to adjust the gain and equalization of the internal microphone. The differences of the averages is obtained by the summer 312. The mid-band compare block 314 compares energy for example in the 500 Hz to 2 kHz region, and controls the gain of gain element 318. The low frequency compare block 316 compares the energy for example in the region below 500 Hz, and controls the LF Adjustment element 320.

The low frequency content of the microphone is adjusted to compensate for any leaks by the LF adjustment element 320. This adjustment can be performed by adjusting the corner frequency or the amplitude of a shelving filter. A shelving filter has two relatively flat response regions, and a transition zone between them with a slope typically less than 12 dB/octave. An overall level adjustment may also be applied. The response at all frequencies could be adjusted, matching the frequency resolution of the averaging system.

The high frequency content of the internal microphone is not expected to match well to the external microphone. Therefore, the gain at high frequencies should be set using information from lower frequencies. For example, the gain above 3 kHz might be best set using an additional adjustment block (not shown) by energy levels measured in the 2-3 kHz range. The output 322 of the automated equalization section can be kept in frequency domain block form, or converted back into a time domain signal by applying an inverse FFT, and then converted into a continuous stream using the well-established overlap and add method. The choice is determined by what additional signal processing will be applied. The insert/remove detect line 324 indicates when the low frequency signal in the ear canal is much higher than outside the ear. When the level is sufficiently high, a signal is set to indicate the listening device is properly inserted in the ear. This signal may be used by other systems to control power status, or to send audio/video device control commands.

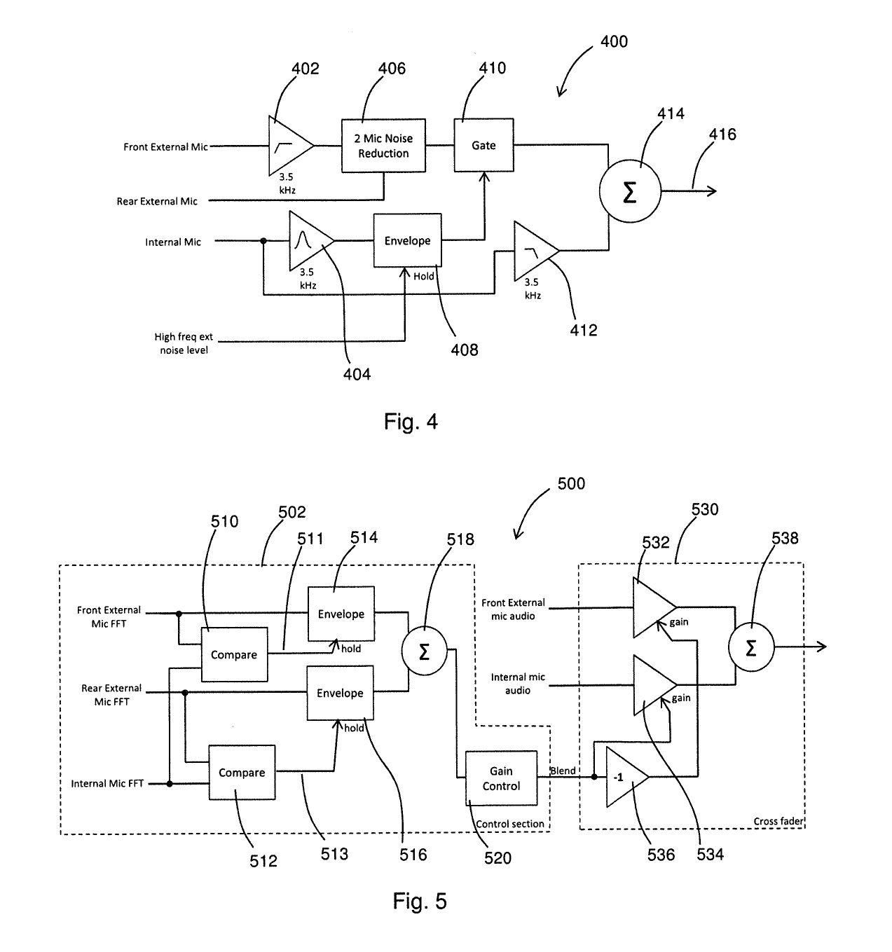

Referring now to FIG. 4, one example of a sibilant replacement module 400 is described. The module 400 includes a high pass filter 402, a band pass filter 404, a 2 microphone noise reduction module 406, an envelope detector module 408, a gate 410, a low pass filter 412, and a summer 414. The control section of the sibilant replacement algorithm first detects the presence of a sibilant by filtering the signal using high pass filter 402, which is set to detect the highest frequencies where the voice signal within the ear canal is louder than the system noise floor. In one example, the band pass filter 404 may be tuned to approximately 3.5 kHz. The level of this signal is tracked over time using an envelope detector module 408, similar to the envelope detectors described elsewhere herein. This detector 408 may use separate attack and decay time constants. A fast attack is useful to avoid missing the start of the sibilant, while a slower decay assures that the end of the sibilant is not lost. A hold signal 418 is used to stop updating the envelope detector when high levels of high frequency external noise signal are detected. This will prevent the sibilant replacement module from attempting to replace a voice sibilant when the external microphone signal contains too much noise to be useful. The exterior microphone signal is filtered by the high pass filter 402 to remove all signals besides sibilance. The high pass filter 402 may be tuned to a similar frequency as the detection filter. The 2 microphone noise reduction module 406 further reduces the environmental noise pickup. A spectral subtraction method such as is widely implemented in cell phones is effective for this. The 2 channel system compares the front and rear microphone patterns to detect when sounds were arriving from the front, and excludes the rear signals.

When a sibilant is detected, the processed external microphone signal is summed with the internal microphone signal by the summer 414. This is done by turning the gate 410 on and off. The switching of the gate 410 is ramped to avoid generating audible clicks. The gate 410 may be an on/off device, or may be a gain stage with a possibly nonlinear mapping between envelope level and the gain of the stage. The relative levels of the external and internal signals are adjusted for natural sounding speech. The internal signal may be low pass filtered at a frequency near that of the external microphone high pass. This reduces the noise of the combined signal at output 416.

The sibilant replacement module 400 may need time to react to speech components and can make the replaced sibilants arrive a too late. One approach is to add a “look-ahead” feature. This feature delays the internal and external signals in the summing path relative to the control path. The external signal delay is placed ahead of the gate, and the internal signal delay is placed just ahead of the summer. This approach matches any delays in the audio path to the delay in the control path, preventing the loss of sibilant onsets.

Referring now to FIG. 5, a microphone selection module 500 is described. The module 500 includes a controls section 502 and a cross fader section 530. Control section 502 includes a first compare module 510, a second compare module 512, a first envelope module 514, a second envelope module 516, a summer 518, and a gain control module 520. The cross fader section 530 includes a first amplifier 532, a second amplifier 534, a third amplifier 536, and a summer 538.

The microphone selection module 500 should use or choose the external microphone signal when environmental noise is low, but change to use the internal microphone signal when environmental noise levels interfere with communication. The change can be a complete substitution of one signal for the other, or can be a blending of the two signals. In one approach, the internal and external signals are automatically blended, with the output level being proportional to a multiple of the noise level, in a dB or logarithmic sense. This approach creates a very smooth changeover, with no sudden changes in voice quality or the environmental noise level.

The first (front) external microphone signal, the second (rear) external microphone signal, and the internal microphone signal are input. These signals are each treated as a continuous series, rectified, low pass filtered using a first order filter, and then decimated. The cutoff frequency of the filter is typically less than 50 Hz. The decimation process greatly reduces the data rate.

The level of environmental noise is measured by extracting the envelope of the noise level. The first step is to extract the envelope of the waveform at the envelope modules 514 and 516. If the signal is treated in block form, the values within the block are summed using the root sum of squares by the summer 518.

The noise level is measured using the external microphone when there is no voice activity. The compare modules 510 and 512 detect when the internal microphone signal is higher than environmental noise from the connected microphone signal to indicate the wearer is talking Voice activity detection can be made more robust by checking that a high sound level is occurring both in the ear canal and in the front external mic signal. This prevents for example chewing sounds from falsely being detected as voice activity. The envelope modules 514 and 516 update only when voice activity is not detected. Other methods of comparison, such as phase difference or correlation may also be used.

The voice level may be much louder than the environmental noise level. Therefore slight delays in voice activity detection may cause large errors in the noise level estimate while voice is active and the noise level is frozen. One way to avoid this error is to substitute a value or an average of several values from a time before the hold becomes active to represent the noise level while voice is active. This is performed by the gain control module 520.

If directional microphone signals are available, it is sometimes useful to combine noise information from each signal direction. This assures that all of the environmental noise is included in the noise assessment. Alternatively, the signal from one or more external microphones can be used without the directional beam forming calculation. There also can be an advantage to using the rear aimed signal for the voice detection comparison. Comparing this to the internal microphone provides the greatest contrast in level. Separate envelopes can be used for each direction of microphone signal, or the signals can be summed at block 518 before computing the second envelope. Signals should be power summed at block 518, using the root sum squares method.

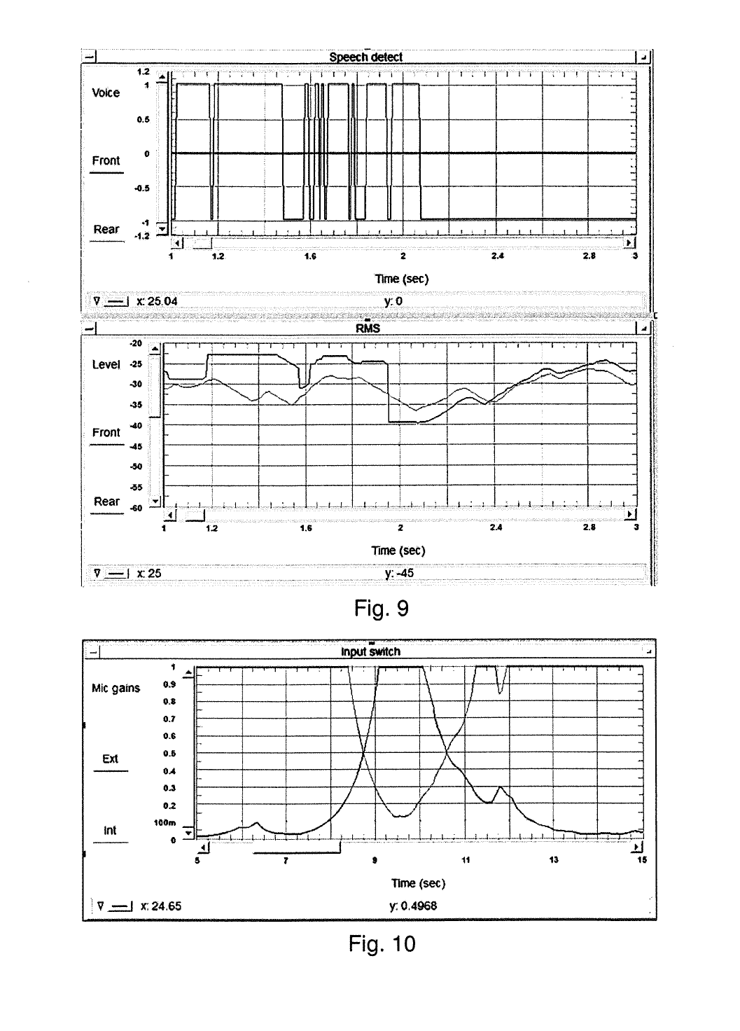

As shown in FIG. 9, envelope levels are held whenever voice activity is detected. The lower graph of the drawing shows the output of the envelope detectors 514 and 516, labeled as “front” and “rear”. When the internal signal is sufficiently greater than the front and rear signals, the respective hold signals go high, and updating of envelope detector 514 is stopped. This prevents the envelope detector from including the user's voice in the assessment of environmental noise. The difference in level between the two envelope signals is used to control the gain of the two microphone signals before summing them together. The gain signals are created by blocks 520 and 536. The gain of the internal microphone path can be set to be proportional to the envelope signal from 518, or to a multiple of this level. The gain is capped at a value of 1. The gain for the external signal is 1 minus the gain of the internal signal, to assure that the sum of the two signals retains the same level at any gain setting. A threshold value is used to determine the envelope level where the mix should start changing. For example, an offset value can be subtracted from the log of the gain signal. The threshold can be set to the noise level where noises start to be annoying during communication. The scaling number adjusts how quickly the blend changes. A value of 1 will cause the level of noise in the blended signal to remain constant as the level of environmental noise increases. Larger scaling values cause a more abrupt transition to the internal microphone as noise level increases. A value of 2 provides a gradual transition, while assuring the external microphone is effectively off in noisy situations. The gain multiplier can then be converted from dB back to a linear form before being used to scale the level of the input signals. Further logic may be added to prevent the system from switching too often between internal and external microphone signals. The logic could prevent the gain from changing until a sufficiently large change in the noise level occurs, wait until a certain amount of time passes before changing the gain, or a combination of both.

An example of the cross fading gains is shown in FIG. 10. In the first time period, only the external microphone is used. As the exterior noise level increases, the gain of the external microphone is gradually reduced, and the gain of the internal microphone is increased. When the external noise stops, the gain of the internal microphone is gradually reduced, and the gain of the external microphone is increased. The overall loudness of the voice pickup is kept nearly constant. The input selection algorithm can be applied to all frequencies, or filters can be used to first divide the spectrum. A separate input selection can be made in each frequency band, then all frequency bands may be summed together. An FFT block or bin may also be used to divide the signal into frequency bands. Separate processing may be applied to each FFT bin, or bins can be combined before processing.

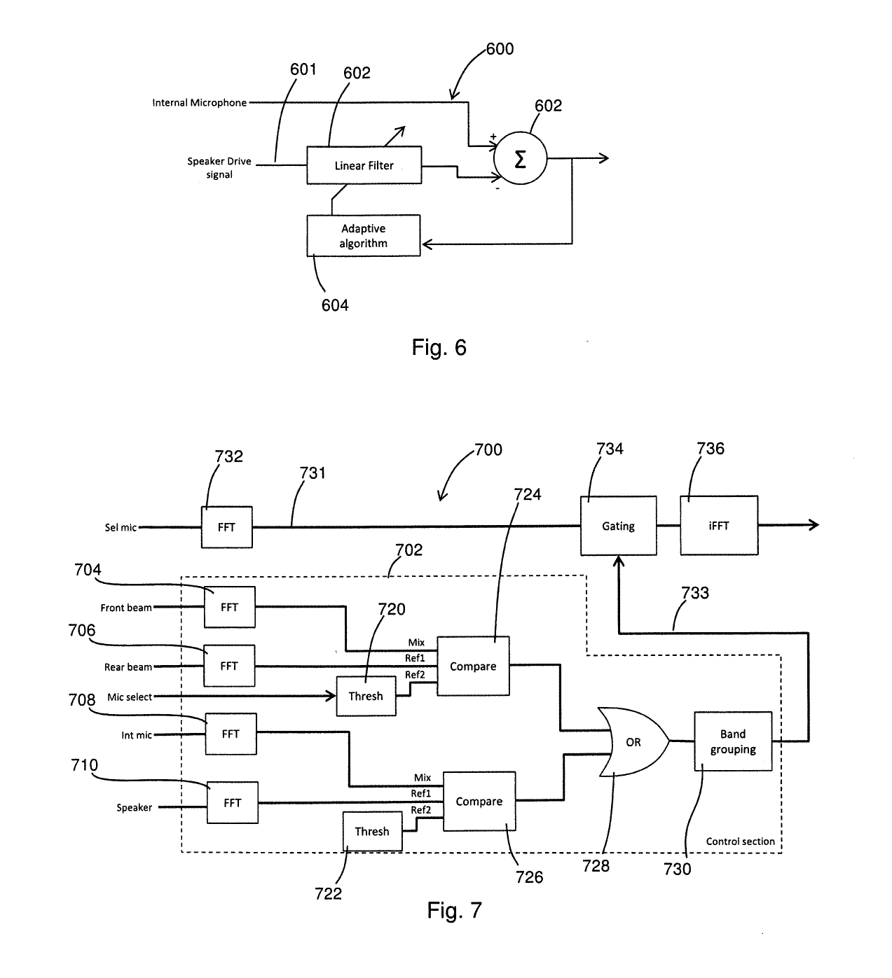

Referring now to FIG. 6, one example of a feedback suppression module 600 is described. The feedback suppression module 600 includes a linear filter 602, an adaptive algorithm or module 604, and a summer 606.

A speaker may be placed into the canal to provide the return portion of a conversation or phone call at input 601. In this case, sound from the speaker will be sensed by the internal microphone. This sound is confounding the sensing of the user's own voice, and may cause feedback howling or echoes, for example, during a phone call. It may also degrade the performance of the various algorithms described herein. The linear finite impulse response filter 602 used with a feedback suppression or echo suppression filter algorithm 604 reduces the level of the speaker signal picked up by the internal microphone. In one example, the adaptive algorithm 604 uses an adaptive filter. In other examples, the algorithm 604 is a least mean squares (LMS) algorithm that is used to adjust the filter 602 and minimize the signal at the output. In another example, the filter may use the recursive least squares (RLS) algorithm. The filter 602 adapts to match the coupling of the speaker and the microphone, which minimizes the output level of the summation 606. The output of the summation 606 retains the internal voice pickup, but reduces the level of the speaker.

Referring now to FIG. 7, one example of a noise reduction module 700 is described. Noise reduction systems typically use spectral subtraction. In this approach, the signal is first separated into blocks of time. Each block is converted to the frequency domain using an FFT. The level in each of the frequency bins is then compared to a reference level. Signals below the reference level are suppressed, while signals above the threshold level are retained. The signals are then converted back into a time domain signal using an inverse FFT. The individual blocks are then reassembled using an overlap and add approach.

The noise reduction system is more accurate if a second channel is used to set the thresholds for the noise reduction. For example, a rear oriented microphone signal will contain less speech than a front facing signal, so provides a better estimate of the environmental noise. This reduces the risk of the noise reduction system removing parts of speech while removing the noise.

For this system, four inputs are available to the noise reduction system: the forward directional microphone signal, the rearward directional microphone signal, the internal microphone signal, and the signal driving the speaker. These signals can be combined to form a more reliable noise reduction system.

More specifically, the module 700 includes a control section 702 that has a first Fast Fourier Transform (FFT) block 704, a second FFT block 706, a third FFT block 708, a fourth FFT block 710, a first threshold block 720, a second threshold block 722, a first compare block 724, a second compare block 726, an OR gate 728, and a band grouping block 730. The module 700 also includes a fifth FFT block 732, a gating block 734, and an inverse FFT block 736.

All input signals are converted to the frequency domain using the FFT blocks 704, 706, 708, 710, and 732. The signals used for detection include the forward directional microphone signal (front beam), rearward directional microphone signal (rear beam), the internal microphone signal (int mic), and speaker drive signals (speaker). In one aspect, the internal microphone signal has been processed to reduce the level of speaker signal contamination, such as the adaptive filter used for feedback suppression. A gain coefficient is determined by comparing at compare module 724 the level of energy in the front beam to the level of energy in the rear beam and to a threshold value from threshold block 720. The threshold value from block 720 may be set to the expected level of self noise from the microphones after directional beam forming. If the signal in the front beam is greater than the comparison signals, then the gain is set to unity. If the front energy is lower than one or more of the comparison signals, the gain is reduced. The gain is calculated separately for each bin of the FFT.

A similar computation is made for the level of the internal microphone compared to the level of the speaker drive signal and the internal microphone by compare block 726. In this case, the threshold value from block 722 would be set to the expected noise signal from the interior microphone.

The gain signals from the two comparisons are then combined using an OR gate 728 or a process that functions similar to an OR gate. This can be done by summing the two gain signals, or by passing the greater of the two gain signals. Spectral subtraction can create tonal artifacts when the noise is not perfectly suppressed. The artifact occurs when small numbers of frequency bands are passed while most of the others are blocked. The effect can be reduced by spreading the control signal for one channel into adjacent channels. The tonal nature of the artifact is reduced, at the expense of less fine control of the noise reduction. This blending of signals occurs in block 730. The signal 731 from the input select section is then multiplied by the gain signal 733 at gating 734, to produce a noise reduced version of the signal. The inverse FFT 736 can be used to convert this signal from the frequency domain to the time domain. The blocks of data can be formed into a continuous using the overlap and add method.

The internal microphone and speaker comparison is effective in detecting when the user is talking, and will be insensitive to environmental noises. However, it may not always detect the sibilant portions of speech, since these have very low energy within the ear canal. Therefore, if only the internal detection were used, the noise reduced signal may be missing some components of speech.

The comparison of the front and rear oriented microphone signals is effective in reducing noise and voice echoes that come from directions oriented away from the front of the user. This comparison is effective at detecting sibilant portions of speech. However, this detection system may not be effective when the environmental noise exceeds the level of the speech, especially if the noise comes from the front of the user. This may trigger false detections of speech, allowing additional noise to pass through the noise reduction system. It will be appreciated that the input selection approaches described herein produce signals that are an estimate of the unvoiced noise level, containing information from both the front and rear directions. These signals can be used to raise the threshold value used in the front/rear comparison section, preventing unwanted noise.

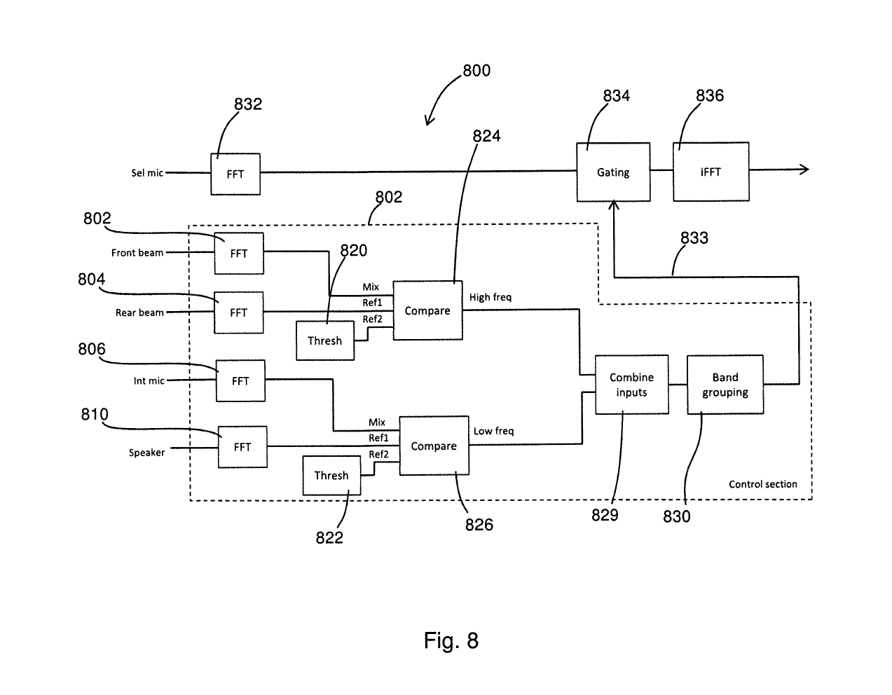

An alternative arrangement for a noise reduction module 800 is shown in FIG. 8. The module 800 includes a control section 802 that has a first Fast Fourier Transform (FFT) block 804, a second FFT block 806, a third FFT block 808, a fourth FFT block 810, a first threshold block 820, a second threshold block 822, a first compare block 824, a second compare block 826, a combine inputs block 828, and a band grouping block 830. The module 800 also includes a fifth FFT module 832, a gating block 834, and an inverse FFT block 836.

The elements in FIG. 8 are the same as in the example of FIG. 7 except that the OR gate 728 is replaced with a combine inputs block 828. Like-numbered elements in FIG. 7 correspond to like-numbered elements in FIG. 8 and their operation is the same. The operation of these elements will not be repeated here.

In the example of FIG. 8, the combine inputs module 828 uses the gain signals from the internal microphone comparison for low and mid frequencies, such as those below 3500 Hz. The gain signals from the exterior microphone comparison are used for high frequencies, such as those above 3500 Hz. This approach uses the internal microphone signal to detect speech in the frequency range where the signal to noise ratio is best. At higher frequencies, the approach uses the external microphone comparison, since the signal to noise ratio is better there at high frequencies.

Other approaches can also be used for the comparison. For example, the phase can be monitored for changes. The relative phase of the front and rear microphones should be stable when the user is talking, but will change rapidly when there is more noise than voice. The threshold levels can also be self-adaptive, using a long term average of the signal, or of valleys in the signal energy to revise the level. This approach advantageously makes the system more resistant to persistent noises.

In another aspect, single channel noise reduction may be applied to individual microphone signals before doing the comparisons. This approach advantageously reduces the noise floor of the detection system, allowing softer speech elements to be passed while still eliminating environmental noises.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method comprising:
providing at least a partial seal between a housing of a hearing instrument and an ear canal;
receiving, from an internal microphone disposed in the ear canal, first signals;
receiving, from an external microphone disposed outside of the ear canal, second signals;
determining a condition of the at least a partial seal, and when the condition of the at least a partial seal indicates a leak, adjusting one or more of the level and the spectrum of the first signals to compensate for the leak and producing first adjusted signals;
blending a first amount of the first adjusted signals with a second amount of the second signals to produce a blended signal, the first amount and the second amount selected based upon a level of noise.

2. The method of claim 1, further comprising applying a wind noise filter to the seconds signal to produce second adjusted signals.

3. The method of claim 1, further comprising replacing selected frequency components in the first adjusted signals to produce sibilant adjusted first signals.

4. The method of claim 1, wherein replacing selected frequency components comprises detecting the presence of a sibilant by filtering an incoming signal using a high pass filter and tracking the filtered signal over time.

5. The method of claim 1, wherein the housing comprises a rubber ear tip or a custom molded housing.

6. The method of claim 1, further comprising:
determining that the hearing instrument has been removed from the ear canal; and
turning the hearing instrument off based on the determining that the hearing instrument has been removed from the ear canal.

7. The method of claim 1, further comprising analyzing a first frequency band of the first signals received from the internal microphone and determining based upon the analysis whether to pass a second frequency band of the second signals received from the external microphone.

8. The method of claim 1, further comprising determining whether there is voice activity in the first signals or the second signals and based upon the determination, determining when to assess a noise level.

9. The method of claim 1, further comprising using a combination of first signals from the first microphone and second signals from the second microphone to minimize an amount of voice pickup.

10. The method of claim 1, further comprising using spectral detection of the first signals from the internal microphone to control a function of an electronic device.

11. The method of claim 1, further comprising using spectral detection of the first signals from the internal microphone to determine if a full seal with the ear canal exists.

12. A signal processing apparatus comprising:
a housing forming at least a partial seal with the ear canal of a user;
an external microphone disposed outside of the ear canal;
an internal microphone disposed in the ear canal;
an electrical interface coupled to the external microphone and the internal microphone and configured to convert analog signals from the internal microphone and external microphone into digital signals;
an automated equalizer module coupled to the interface and configured to determine a condition of the at least a partial seal and adjust a signal of the internal microphone based on the condition of the at least a partial seal;
a blend module coupled to the interface and the automated equalizer module, the blend module configured to blend a first amount of the first adjusted signals with a second amount of the second signals to produce a blended signal, the first amount and the second amount selected based upon a level of noise.

13. The apparatus of claim 12, further comprising a wind noise reduction module coupled to the interface and configured to apply a wind noise filter to a signal of the external microphone.

14. The apparatus of claim 12, further comprising a sibilant replacement module configured to replace selected frequency components in received speech signals from one or more of the internal microphone and the external microphone.

15. The apparatus of claim 14, wherein the sibilant replacement module includes a high pass filter and an envelope detector module, the sibilant replacement module configured to detect the presence of a sibilant by filtering an incoming signal using the high pass filter and tracking the filtered signal over time using the envelope detector module.

16. The apparatus of claim 12, further comprising a feedback suppression module coupled to the blending module and configured to reduce one or more of feedback and echo and produce a signal to be sent to a speaker.

17. The apparatus of claim 16, further comprising:
an automatic gain control module coupled to an output of the feedback suppression module and configured to control a voice volume of the output of the feedback suppression module.

18. The apparatus of claim 1, further comprising:
a beam form module coupled to the interface, the wind noise reduction module, and the sibilant replacement module, the beam form module configured to combine signals from the external microphone and the internal microphone to minimize an amount of voice pickup.

19. The apparatus of claim 1, wherein the housing is a rubber ear tip housing or a custom molded housing.

20. The apparatus of claim 1, further comprising:
a second external microphone disposed outside of the ear canal and coupled to the interface.
